(19) United States
(12) Patent Application Publication
(10) Pub. No.: US 2021/0356605 A1
(43) Pub. Date: Nov. 18, 2021

(54) METHOD, APPARATUS, DEVICE AND MEDIUM FOR CALIBRATING TEMPERATURE DRIFT

(71) Applicant: BEIJING BAIDU NETCOM SCIENCE AND TECHNOLOGY CO., LTD., Beijing (CN)

(72) Inventors: Bing LI, Beijing (CN); Zhipeng ZHOU, Beijing (CN)

(21) Appl. No.: 17/117,504

(22) Filed: Dec. 10, 2020

(30) Foreign Application Priority Data
May 14, 2020 (CN) 202010408689.7

(51) Int. Cl. G01S 19/47; G01P 15/08; G01P 21/00; G01C 19/00; G01S 19/52; G01C 25/00

(52) U.S. Cl. CPC G01S 19/47; G01P 15/08; G01C 25/005; G01C 19/00; G01S 19/52; G01P 21/00

(57) ABSTRACT

A method, an apparatus, a device, and a medium for calibrating a temperature drift are provided. The method includes: acquiring a first measurement value and a second measurement value, the first measurement value being a measurement value of a to-be-measured quantity at a current moment determined based on an inertial measurement unit, and the second measurement value being a measurement value of the to-be-measured quantity at the current moment determined based on a global positioning system; and determining a temperature drift calibration value of the inertial measurement unit at the current moment based on the first measurement value and the second measurement value.

### CROSS-REFERENCE TO RELATED APPLICATIONS

This application claims the priority to Chinese Patent Application No.202010408689.7, titled “METHOD, APPARATUS, DEVICE AND MEDIUM FOR CALIBRATING TEMPERATURE DRIFT,” filed on May 14, 2020, the content of which is incorporated herein by reference in its entirety.

### TECHNICAL FIELD

Embodiments of the present disclosure relate to computer technology, specifically to in-vehicle map technology, and more specifically to a method, apparatus, device, and medium for calibrating a temperature drift.

### BACKGROUND

In the field of on-board map technology, a built-in inertial measurement unit of a traveling device is one of the most important sensors. The implementation of any navigation dead reckoning algorithm directly depends on the inertial measurement unit. Therefore, the performance of the inertial measurement unit directly affects the accuracy and reliability of the navigation dead reckoning algorithm.

### SUMMARY

Embodiments of the present disclosure disclose a method, apparatus, device, and medium for calibrating a temperature drift, to realize a technical effect of determining a current temperature drift value of an inertial measurement unit in real time.

In a first aspect, embodiments of the disclosure discloses a method for calibrating a temperature drift, the method including:

acquiring a first measurement value and a second measurement value; the first measurement value being a measurement value of a to-be-measured quantity at a current moment determined based on an inertial measurement unit, and the second measurement value being a measurement value of the to-be-measured quantity at the current moment determined based on a global positioning system; and

determining a temperature drift calibration value of the inertial measurement unit at the current moment based on the first measurement value and the second measurement value.

Alternatively, the determining a temperature drift calibration value of the inertial measurement unit at the current moment based on the first measurement value and the second measurement value, includes:

determining a difference between the first measurement value and the second measurement value;

acquiring a temperature drift calibration value of the inertial measurement unit in a stationary state; and

determining the temperature drift calibration value of the inertial measurement unit at the current moment, based on the difference and the temperature drift calibration value of the inertial measurement unit in the stationary state.

Alternatively, the to-be-measured quantity is speed, the first measurement value is a first speed value, the second measurement value is a second speed value, and the temperature drift calibration value of the inertial measurement unit in the stationary state is a temperature drift calibration value of an accelerometer of the inertial measurement unit in the stationary state;

correspondingly, the determining the temperature drift calibration value of the inertial measurement unit at the current moment, based on the difference and the temperature drift calibration value of the inertial measurement unit in the stationary state, includes:

determining a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment.

Alternatively, the determining a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment, includes:

determining the temperature drift calibration value bias1 of the accelerometer of the inertial measurement unit at the current moment according to a formula as follows:

Delta_v=((a−bias0−bias1)*delta_time1)*scale1;

where, Delta_v is the difference between the first speed value and the second speed value, a is the acceleration value output by the accelerometer at the current moment, bias0 is the temperature drift calibration value of the accelerometer of the inertial measurement unit in the stationary state, delta_time1 is integral calculation time corresponding to the accelerometer of the inertial measurement unit, and scale1 is a preset scale value.

Alternatively, the determining the temperature drift calibration value of the accelerometer of the inertial measurement unit in the stationary state, includes:

acquiring an acceleration value output by the accelerometer of the inertial measurement unit in the stationary state within a first preset period;

determining an initial temperature drift value of the accelerometer of the inertial measurement unit in the stationary state based on the acceleration value within the first preset period;

determining an initial speed value based on the acceleration value within the first preset period and the initial temperature drift value; and

determining the temperature drift calibration value of the accelerometer of the inertial measurement unit in the stationary state based on the initial speed value.

Alternatively, the determining the temperature drift calibration value of the accelerometer of the inertial measurement unit in the stationary state based on the initial speed value, includes:

determining the initial temperature drift value as the temperature drift calibration value of the accelerometer of the inertial measurement unit in the stationary state, if the initial speed value is 0; and

correcting the initial temperature drift value to obtain the temperature drift calibration value of the accelerometer of the inertial measurement unit in the stationary state, if the initial speed value is not 0.

Alternatively, after the determining the temperature drift calibration value of the accelerometer of the inertial measurement unit in the stationary state based on the initial speed value, the method further includes:

acquiring an acceleration value output by the accelerometer of the inertial measurement unit within a second preset period, when the inertial measurement unit is in the stationary state again; and

updating the temperature drift calibration value of the accelerometer of the inertial measurement unit in the stationary state, based on the acceleration value within the second preset period.

Alternatively, the to-be-measured quantity is an angle, the first measurement value is a first attitude angle, the second measurement value is a second attitude angle, and the temperature drift calibration value of the inertial measurement unit in the stationary state is a temperature drift calibration value of a gyroscope of the inertial measurement unit in the stationary state;

correspondingly, the determining the temperature drift calibration value of the inertial measurement unit at the current moment, based on the difference and the temperature drift calibration value of the inertial measurement unit in the stationary state, includes:

determining a temperature drift calibration value of the gyroscope of the inertial measurement unit at the current moment, based on a difference between the first attitude angle and the second attitude angle, the temperature drift calibration value of the gyroscope of the inertial measurement unit in the stationary state, and an angular velocity value output by the gyroscope at the current moment.

Alternatively, the determining a temperature drift calibration value of the gyroscope of the inertial measurement unit at the current moment, based on a difference between the first attitude angle and the second attitude angle, the temperature drift calibration value of the gyroscope of the inertial measurement unit in the stationary state, and an angular velocity value output by the gyroscope at the current moment, includes:

determining the temperature drift calibration value bias3 of the gyroscope of the inertial measurement unit at the current moment according to a formula as follows:

Delta_yaw=((g−bias2−bias3)*delta_time2)*scale2

where, Delta_yaw is the difference between the first attitude angle and the second attitude angle, g is the angular velocity value output by the gyroscope at the current moment, bias2 is the temperature drift calibration value of the gyroscope of the inertial measurement unit in the stationary state, delta_time2 is integral calculation time corresponding to the gyroscope of the inertial measurement unit, and scale2 is a preset scale value.

Alternatively, the determining the temperature drift calibration value of the gyroscope of the inertial measurement unit in the stationary state, includes:

acquiring an angular velocity value output by the gyroscope of the inertial measurement unit in the stationary state within a first preset period;

determining an initial temperature drift value of the gyroscope of the inertial measurement unit in the stationary state based on the angular velocity value within the first preset period;

determining an initial attitude angle based on the angular velocity value within the first preset period and the initial temperature drift value; and

determining the temperature drift calibration value of the gyroscope of the inertial measurement unit in the stationary state based on the initial attitude angle.

Alternatively, the determining the temperature drift calibration value of the gyroscope of the inertial measurement unit in the stationary state based on the initial attitude angle, includes:

determining the initial temperature drift value as the temperature drift calibration value of the gyroscope of the inertial measurement unit in the stationary state, if the initial attitude angle is 0; and

correcting the initial temperature drift value to obtain the temperature drift calibration value of the gyroscope of the inertial measurement unit in the stationary state, if the initial attitude angle is not 0.

Alternatively, after the determining the temperature drift calibration value of the gyroscope of the inertial measurement unit in the stationary state based on the initial attitude angle, the method further includes:

acquiring an angular velocity value output by the gyroscope of the inertial measurement unit within a second preset period, when the inertial measurement unit is in the stationary state again; and

updating the temperature drift calibration value of the gyroscope of the inertial measurement unit in the stationary state, based on the angular velocity value within the second preset period.

Alternatively, the method further includes:

correcting output information of the inertial measurement unit, based on the temperature drift calibration value of the inertial measurement unit, and obtaining a navigation dead reckoning result, based on the corrected output information and a navigation dead reckoning algorithm.

In a second aspect, embodiments of the disclosure disclose an apparatus for calibrating a temperature drift, the apparatus including:

a measurement value acquisition module, configured to acquire a first measurement value and a second measurement value; the first measurement value being a measurement value of a to-be-measured quantity at a current moment determined based on an inertial measurement unit, and the second measurement value being a measurement value of the to-be-measured quantity at the current moment determined based on a global positioning system; and

a temperature drift calibration value determination module, configured to determine a temperature drift calibration value of the inertial measurement unit at the current moment based on the first measurement value and the second measurement value.

In a third aspect, embodiments of the disclosure discloses an electronic device, including

at least one processor; and

a memory, communicatively connected to the at least one processor;

where the memory stores instructions executable by the at least one processor, and the instructions, when executed by the at least one processor, cause the at least one processor to perform the method for calibrating a temperature drift according to any embodiment of the disclosure.

In a further aspect, embodiments of the disclosure discloses a non-transitory computer readable storage medium, storing computer instructions, the computer instructions, being used to cause the computer to perform the method for calibrating a temperature drift according to any embodiment of the disclosure.

### BRIEF DESCRIPTION OF THE DRAWINGS

The accompanying drawings are used to better understand the present solution and do not constitute a limitation to the present disclosure, in which:

FIG. 1 is a flowchart of a method for calibrating a temperature drift disclosed in Embodiment 1 of the present disclosure;

FIG. 2 is a flowchart of another method for calibrating a temperature drift disclosed in Embodiment 2 of the present disclosure;

FIG. 3 is a flowchart of another method for calibrating a temperature drift disclosed in Embodiment 3 of the present disclosure;

FIG. 4 is a flowchart of another method for calibrating a temperature drift disclosed in Embodiment 4 of the present disclosure;

FIG. 5 is a schematic structural diagram of an apparatus for calibrating a temperature drift disclosed in Embodiment 5 of the present disclosure; and

FIG. 6 is a block diagram of an electronic device disclosed in Embodiment 6 of the present disclosure.

### DETAILED DESCRIPTION OF EMBODIMENTS

The following describes example embodiments of the present disclosure in conjunction with the accompanying drawings, which includes various details of the embodiments of the present disclosure to facilitate understanding, and they should be considered as merely exemplary. Therefore, those of ordinary skill in the art should understand that various changes and modifications may be made to the embodiments described herein without departing from the scope and spirit of the present disclosure. Also, for clarity and conciseness, descriptions of well-known functions and structures are omitted in the following description.

According to the technical solution of the embodiments of the present disclosure, by using the measurement value of the to-be-measured quantity at the current moment determined based on the inertial measurement unit as the first measurement value, and using the measurement value of the to-be-measured quantity at the current moment determined based on the global positioning system as the second measurement value, and finally determining the temperature drift calibration value of the inertial measurement unit at the current moment based on the first measurement value and the second measurement value, the technical effect of determining the current temperature drift calibration value of the inertial measurement unit in real time is achieved, which lays a data foundation for subsequent compensation of the temperature drift in a navigation dead reckoning algorithm, thereby improving the accuracy of a navigation result.

### Embodiment 1

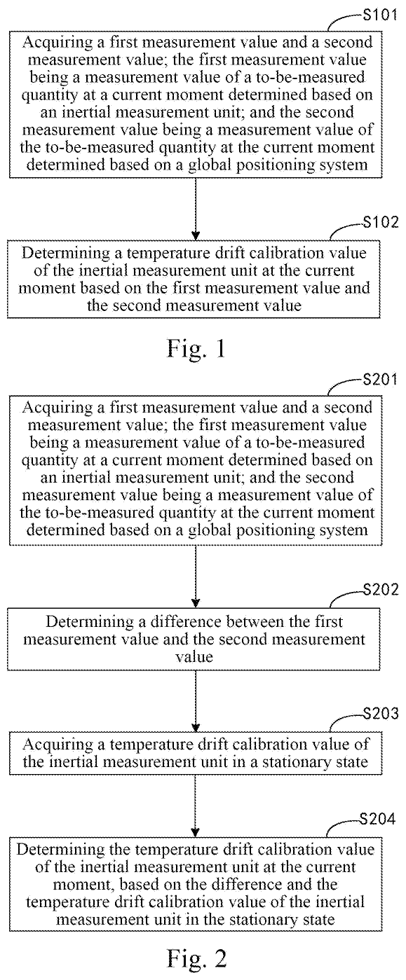

FIG. 1 is a flowchart of a method for calibrating a temperature drift disclosed in Embodiment 1 of the present disclosure. The present embodiment may be applied to the case that a traveling device uses an on-board navigation. The method of the present embodiment may be performed by an apparatus for calibrating a temperature drift. The apparatus may be implemented by software and/or hardware, and may be integrated on any electronic device having computing power, such as a server.

As shown in FIG. 1, the method for calibrating a temperature drift disclosed in the present embodiment may include S101 and S102.

S101 includes acquiring a first measurement value and a second measurement value; the first measurement value being a measurement value of a to-be-measured quantity at a current moment determined based on an inertial measurement unit (IMU); and the second measurement value being a measurement value of the to-be-measured quantity at the current moment determined based on a global positioning system (GPS).

Inertial measurement unit is an apparatus for measuring a three-axis attitude angle (or angular rate) and acceleration of an object. Generally, an inertial measurement unit includes three single-axis accelerometers and three single-axis gyroscopes. The accelerometers measure acceleration values of three independent axes of the object in a carrier coordinate system, while the gyroscopes detect angular velocity values of the carrier relative to a navigation coordinate system, and resolve an attitude of the object. Global positioning system is a high-precision radio navigation positioning system based on aerial satellites. The system can provide accurate geographic position, vehicle speed and attitude information anywhere in the world and near earth space. In the present embodiment, the to-be-measured quantity includes speed and/or angle, etc.

Specifically, the inertial measurement unit is built in a traveling device, and the traveling device includes but is not limited to automobile, ship and aircraft. When the traveling device is in a traveling state, the measurement value of the to-be-measured quantity determined by the inertial measurement unit is acquired in real time, for example, a speed value of the traveling device is obtained by integrating an acceleration value at the current moment by the accelerometer in the inertial measurement unit, or an attitude angle of the traveling device obtained by integrating an angular velocity at the current moment by the gyroscope in the inertial measurement unit. Meanwhile, the measurement value of the to-be-measured quantity at the current moment determined based on the global positioning system is acquired from a global positioning system built in the traveling device, such as a speed value of the traveling device at the current moment determined by the global positioning system, and an attitude angle of the traveling device at the current moment determined by the global positioning system.

Alternatively, if the to-be-measured quantity is speed, the first measurement value is a first speed value, and the second measurement value is a second speed value.

Alternatively, if the to-be-measured quantity is an angle, the first measurement value is a first attitude angle, and the second measurement value is a second attitude angle.

By using the measurement value of the to-be-measured quantity at the current moment determined based on the inertial measurement unit as the first measurement value, and using the measurement value of the to-be-measured quantity at the current moment determined based on the global positioning system as the second measurement value, a data foundation is laid for subsequent determination of a temperature drift calibration value of the inertial measurement unit at the current moment based on the first measurement value and the second measurement value.

S102 includes determining a temperature drift calibration value of the inertial measurement unit at the current moment based on the first measurement value and the second measurement value.

The temperature drift calibration value of the inertial measurement unit at the current moment represents the temperature drift calibration value of the inertial measurement unit during traveling of the traveling device.

Specifically, a difference value between the first measurement value and the second measurement value is determined, for example, a difference between the first measurement value and the second measurement value is determined, and for another example, a ratio between the first measurement value and the second measurement value is determined. Based on the difference between the first measurement value and the second measurement value, an output value of the inertial measurement unit at the current moment, integral calculation time corresponding to the inertial measurement unit and a preset scale value, the temperature drift calibration value of the inertial measurement unit at the current moment is determined. If the to-be-measured quantity is speed, the output value of the inertial measurement unit at the current moment is acceleration, the integral calculation time corresponding to the inertial measurement unit is integral calculation time corresponding to the accelerometer, and the temperature drift calibration value of the inertial measurement unit at the current moment is a temperature drift calibration value of the accelerometer of the inertial measurement unit at the current moment; and if the to-be-measured quantity is an angle, the output value of the inertial measurement unit at the current moment is angular velocity, the integral calculation time corresponding to the inertial measurement unit is integral calculation time corresponding to the gyroscope, and the temperature drift calibration value of the inertial measurement unit at the current moment is a temperature drift calibration value of the gyroscope of the inertial measurement unit at the current moment. The preset scale value is a constant, which may be configured according to actual needs.

Alternatively, the temperature drift calibration value of the inertial measurement unit at the current moment is determined according to the formula as follows:

Delta_x=((y−bias)*delta_time)*scale

Here, Delta_x represents the difference between the first measurement value and the second measurement value, y represents the output value of the inertial measurement unit at the current moment, bias represents the temperature drift calibration value of the inertial measurement unit at the current moment, delta_time represents the integral calculation time corresponding to the inertial measurement unit, and scale represents the preset scale value.

By determining the temperature drift calibration value of the inertial measurement unit at the current moment based on the first measurement value and the second measurement value, the technical effect of determining the temperature drift calibration value of the inertial measurement unit at the current moment in real time is achieved.

According to the technical solution of the present embodiment, by using the measurement value of the to-be-measured quantity at the current moment determined based on the inertial measurement unit as the first measurement value, and using the measurement value of the to-be-measured quantity at the current moment determined based on the global positioning system as the second measurement value, and finally determining the temperature drift calibration value of the inertial measurement unit at the current moment based on the first measurement value and the second measurement value, a technical effect of determining the current temperature drift calibration value of the inertial measurement unit in real time is achieved, which lays a data foundation for subsequent compensation of the temperature drift in a navigation dead reckoning algorithm, so as to improve the accuracy of a navigation result.

### Embodiment 2

FIG. 2 is a flowchart of another method for calibrating a temperature drift disclosed in Embodiment 2 of the present disclosure, which is further optimized and expanded based on the above technical solution, and may be combined with the above various alternative embodiments. As shown in FIG. 2, the method may include S201 to S204.

S201 includes acquiring a first measurement value and a second measurement value; the first measurement value being a measurement value of a to-be-measured quantity at a current moment determined based on an inertial measurement unit; and the second measurement value being a measurement value of the to-be-measured quantity at the current moment determined based on a global positioning system.

Step 202 includes determining a difference between the first measurement value and the second measurement value.

Specifically, if the to-be-measured quantity is speed, the first measurement value is a first speed value, the second measurement value is a second speed value, correspondingly, the difference between the first measurement value and the second measurement value is a difference between the first speed value and the second speed value; and if the to-be-measured quantity is an angle, the first measurement value is a first attitude angle, the second measurement value is a second attitude angle, correspondingly, the difference between the first measurement value and the second measurement value is a difference between the first attitude angle and the second attitude angle.

S203 includes acquiring a temperature drift calibration value of the inertial measurement unit in a stationary state.

The stationary state represents a state where the speed of a traveling device is zero, which may be determined by apparatuses on the traveling device including the global positioning system or a speed measuring radar.

Specifically, an output value of the inertial measurement unit in the stationary state within a first preset period is acquired; an initial temperature drift value of the inertial measurement unit in the stationary state is determined based on the output value within the first preset period; then an initial feature value is determined based on the output value within the first preset period and the initial temperature drift value; and finally the temperature drift calibration value of the inertial measurement unit is determined in the stationary state based on the initial feature value. Here, if the to-be-measured quantity is speed, the output value of the inertial measurement unit within the first preset period is an acceleration value of the accelerometer within the first preset period, the initial temperature drift value of the inertial measurement unit in the stationary state is an initial temperature drift value of the accelerometer in the stationary state, the initial feature value is an initial speed value, and the temperature drift calibration value of the inertial measurement unit in the stationary state is a temperature drift calibration value of the accelerometer in the stationary state; and if the to-be-measured quantity is an angle, the output value of the inertial measurement unit within the first preset period is an angular velocity value of the gyroscope within the first preset period, the initial temperature drift value of the inertial measurement unit in the stationary state is an initial temperature drift value of the gyroscope in the stationary state, the initial feature value is an initial attitude angle, and the temperature drift calibration value of the inertial measurement unit in the stationary state is a temperature drift calibration value of the gyroscope in the stationary state.

Step 204 includes determining the temperature drift calibration value of the inertial measurement unit at the current moment, based on the difference and the temperature drift calibration value of the inertial measurement unit in the stationary state.

Specifically, the temperature drift calibration value of the inertial measurement unit at the current moment is determined according to the formula as follows:

Delta_x=((y−biasx−bias)*delta_time)*scale

Here, Delta_x represents the difference between the first measurement value and the second measurement value, y represents the output value of the inertial measurement unit at the current moment, biasx represents the temperature drift calibration value of the inertial measurement unit in the stationary state, bias represents the temperature drift calibration value of the inertial measurement unit at the current moment, delta_time represents the integral calculation time corresponding to the inertial measurement unit, and scale represents the preset scale value. If the to-be-measured quantity is speed, the output value of the inertial measurement unit at the current moment is acceleration, the temperature drift calibration value of the inertial measurement unit at the current moment is a temperature drift calibration value of the accelerometer at the current moment, the integral calculation time corresponding to the inertial measurement unit is integral calculation time corresponding to the accelerometer, and the temperature drift calibration value of the inertial measurement unit at the current moment is a temperature drift calibration value of the accelerometer of the inertial measurement unit at the current moment; and if the to-be-measured quantity is an angle, the output value of the inertial measurement unit at the current moment is angular velocity, the temperature drift calibration value of the inertial measurement unit in the stationary state is a temperature drift calibration value of the gyroscope in the stationary state, the integral calculation time corresponding to the inertial measurement unit is integral calculation time corresponding to the gyroscope, and the temperature drift calibration value of the inertial measurement unit at the current moment is a temperature drift calibration value of the gyroscope of the inertial measurement unit at the current moment. The preset scale value is a constant, which may be set according to actual needs.

In the present embodiment, the temperature drift calibration value of the inertial measurement unit at the current moment is determined based on the difference between the first measurement value and the second measurement value and the temperature drift calibration value of the inertial measurement unit in the stationary state, since calculation of the temperature drift calibration value in the stationary state is relatively accurate, the temperature drift calibration value in the stationary state is used as a calculation item, and the accuracy of the finally determined temperature drift calibration value of the inertial measurement unit at the current moment may be improved.

On the basis of foregoing embodiments, the method further includes:

correcting output information of the inertial measurement unit, based on the temperature drift calibration value of the inertial measurement unit, and obtaining a navigation dead reckoning result, based on the corrected output information and a navigation dead reckoning algorithm.

The temperature drift calibration value of the inertial measurement unit includes the temperature drift calibration value of the inertial measurement unit in the stationary state, and the temperature drift calibration value of the inertial measurement unit at the current moment, that is, no matter whether the traveling speed of the traveling device is 0 or not, the output information of the inertial measurement unit is corrected in real time, and the navigation dead reckoning result is obtained based on the corrected output information and the navigation dead reckoning algorithm.

By correcting the output information of the inertial measurement unit based on the temperature drift calibration value of the inertial measurement unit, a technical effect of temperature drift compensation of the inertial measurement unit is achieved; and by obtaining the navigation dead reckoning result, based on the corrected output information and the navigation dead reckoning algorithm, the accuracy and reliability of the navigation dead reckoning result are improved.

### Embodiment 3

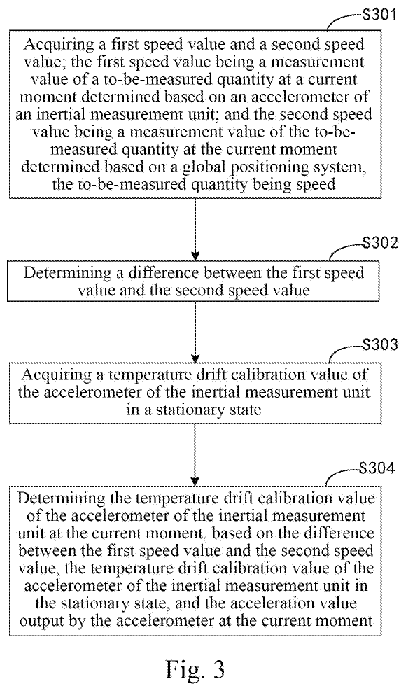

FIG. 3 is a flowchart of another method for calibrating a temperature drift disclosed in Embodiment 3 of the present disclosure, which is further optimized and expanded based on the above technical solution, and may be combined with the above various alternative embodiments. As shown in FIG. 3, the method may include S301 to S304.

S301 includes acquiring a first speed value and a second speed value; the first speed value being a measurement value of a to-be-measured quantity at a current moment determined based on an accelerometer of an inertial measurement unit; and the second speed value being a measurement value of the to-be-measured quantity at the current moment determined based on a global positioning system, the to-be-measured quantity being speed.

S302 includes determining a difference between the first speed value and the second speed value.

S303 includes acquiring a temperature drift calibration value of the accelerometer of the inertial measurement unit in a stationary state.

Alternatively, S303 includes steps 1) to 4).

Step 1) includes acquiring an acceleration value output by the accelerometer of the inertial measurement unit in the stationary state within a first preset period.

Here, the first preset period may be arbitrarily set according to requirements, and the preferred first preset period is 1 minute.

Step 2) includes determining an initial temperature drift value of the accelerometer of the inertial measurement unit in the stationary state based on the acceleration value within the first preset period.

Specifically, the acceleration values within the first preset period are divided into segments, and an average value corresponding to each segment is calculated, and the median of the average values is used as the initial temperature drift value of the accelerometer of the inertial measurement unit in the stationary state.

For example, assuming that the first preset period is 1 minute, for acceleration values output by the accelerometer of the inertial measurement unit within 1 minute, an average value of acceleration values for every 100 milliseconds is acquired, that is, 600 average values are acquired, and the median of these 600 average values is used as the initial temperature drift value of the accelerometer of the inertial measurement unit in the stationary state.

Step 3) includes determining an initial speed value based on the acceleration value within the first preset period and the initial temperature drift value.

Specifically, the initial temperature drift value is subtracted from the acceleration value at each moment within the first preset period respectively, and integration calculation is performed on subtraction results to obtain the initial speed value within the first preset period. The specific period of each moment may be set arbitrarily according to requirements, and alternatively includes 1 millisecond or 10 milliseconds.

Step 4) includes determining the temperature drift calibration value of the accelerometer of the inertial measurement unit in the stationary state based on the initial speed value.

Alternatively, if the initial speed value is 0, the initial temperature drift value is determined as the temperature drift calibration value of the accelerometer of the inertial measurement unit in the stationary state; and if the initial speed value is not 0, the initial temperature drift value is corrected to obtain the temperature drift calibration value of the accelerometer of the inertial measurement unit in the stationary state.

Here, if the initial speed value is 0, it indicates that the determined initial temperature drift value is accurate, accordingly, the initial temperature drift value is determined as the temperature drift calibration value of the accelerometer of inertial measurement unit in the stationary state. If the initial speed value is not 0, it indicates that the determined initial temperature drift value is deviated, then the initial temperature drift value is corrected. The correction process includes: subtracting a ratio of the initial speed value to the first preset period from the initial temperature drift value, to acquire a calculation result as the corrected initial temperature drift value.

For example, the initial temperature drift value is 1 m/s², the initial speed value is 0.5 m/s, the first preset period is 1 min, and a calculation result of

$$1 m \text{/} {s}^{2} - \frac{0.5 m \text{/} s}{1 min}$$

is used as the corrected initial temperature drift value. Finally, the corrected initial temperature drift value is used as the temperature drift calibration value of the accelerometer of the inertial measurement unit in the stationary state.

S304 includes determining the temperature drift calibration value of the accelerometer of the inertial measurement unit at the current moment, based on the difference between the first speed value and the second speed value, the temperature drift calibration value of the accelerometer of the inertial measurement unit in the stationary state, and the acceleration value output by the accelerometer at the current moment.

Alternatively, the temperature drift calibration value of the accelerometer of the inertial measurement unit at the current moment is determined according to the formula as follows:

Delta_v=((a−bias0−bias1)*delta_time1)*scale1

Here, Delta_v is the difference between the first speed value and the second speed value, a is the acceleration value output by the accelerometer at the current moment, bias0 is the temperature drift calibration value of the accelerometer of the inertial measurement unit in the stationary state, delta_time is the integral calculation time corresponding to the accelerometer of the inertial measurement unit, which is about 2 s, and scale is the preset scale value, preferably taking a value between 1-2.

According to the technical solution of the present embodiment, by acquiring the first speed value and the second speed value, determining the difference between the first speed value and the second speed value, and acquiring the temperature drift calibration value of the accelerometer of the inertial measurement unit in the stationary state and finally determining the temperature drift calibration value of the accelerometer of the inertial measurement unit at the current moment, based on the difference between the first speed value and the second speed value, the temperature drift calibration value of the accelerometer of the inertial measurement unit in the stationary state, and the acceleration value output by the accelerometer at the current moment, a technical effect of determining the current temperature drift calibration value of the accelerometer of the inertial measurement unit in real time is achieved, which lays a data foundation for subsequent compensation of the accelerometer temperature drift in a navigation dead reckoning algorithm, thereby improving the accuracy of a navigation result.

On the basis of foregoing embodiments, after the “determining the temperature drift calibration value of the accelerometer of the inertial measurement unit in the stationary state based on the initial speed value”, the method further includes steps A and B.

Step A includes: acquiring an acceleration value output by the accelerometer of the inertial measurement unit within a second preset period, when the inertial measurement unit is in the stationary state again.

The second preset period may be configured according to requirements, and is preferably 30 s.

Specifically, when the traveling speed of the traveling device is 0 again, the acceleration value output by the accelerometer of the inertial measurement unit within the second preset period is acquired.

Step B includes updating the temperature drift calibration value of the accelerometer of the inertial measurement unit in the stationary state, based on the acceleration value within the second preset period.

Specifically, for the acceleration values within the second preset period, acceleration values within a preset error range of the previous temperature drift calibration value of the accelerometer of the inertial measurement unit in the stationary state are used as target acceleration values, and an average value of the target acceleration values is used as the updated temperature drift calibration value of the accelerometer of the inertial measurement unit in the stationary state. The preset error range is preferably 30%-50%. The influence of noise on the temperature drift calibration value may be avoided by setting the preset error range.

By updating the temperature drift calibration value of the accelerometer in the stationary state, based on the acceleration values output by the accelerometer within the second preset period, when the inertial measurement unit is in the stationary state again, a technical effect of updating the temperature drift calibration value of the accelerometer in the stationary state is achieved, so that the accuracy of the temperature drift calibration value of the accelerometer in the stationary state can be guaranteed even when the traveling device switches from moving and stopping for multiple times, thus ensuring the accuracy of the temperature drift calibration value of the accelerometer at the current moment.

On the basis of foregoing embodiments, the acceleration value output by the accelerometer of the inertial measurement unit is an acceleration value output by a sensitive axis of the accelerometer; correspondingly, the temperature drift calibration value of the accelerometer of the inertial measurement unit in the stationary state is the temperature drift calibration value of the sensitive axis of the accelerometer of the inertial measurement unit in the stationary state.

Specifically, integrations are performed on the accelerations output by the three axes in the accelerometer to obtain speed values, which are respectively compared with the speed value determined by the global positioning system, and an axis corresponding to the speed value having the minimum error is used as the sensitive axis of the accelerometer.

By using the acceleration value output by the sensitive axis of the accelerometer as the acceleration value output by the accelerometer of the inertial measurement unit, on the premise of saving a follow-up method workload, it is ensured that the finally obtained result of the temperature drift calibration value of the inertial measurement unit at the current moment is more accurate.

### Embodiment 4

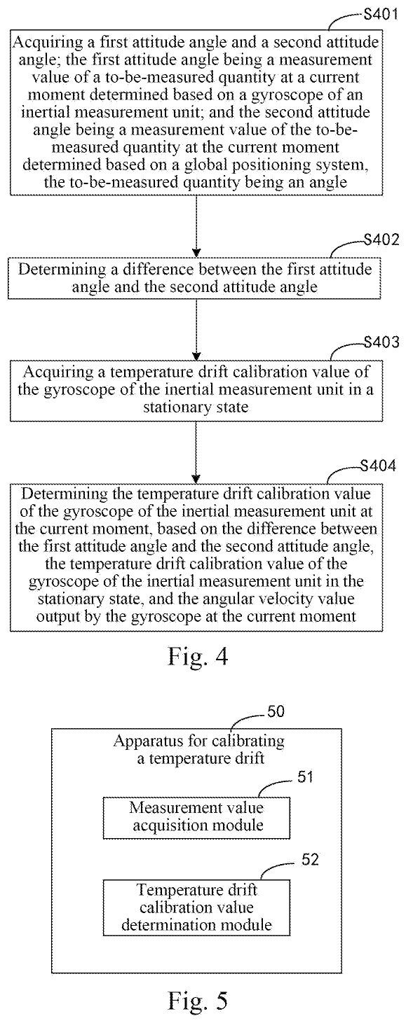

FIG. 4 is a flowchart of another method for calibrating a temperature drift disclosed in Embodiment 4 of the present disclosure, which is further optimized and expanded based on the above technical solution, and may be combined with the above various alternative embodiments. As shown in FIG. 4, the method may include S401 to S403.

S401 includes acquiring a first attitude angle and a second attitude angle; the first attitude angle being a measurement value of a to-be-measured quantity at a current moment determined based on a gyroscope of an inertial measurement unit; and the second attitude angle being a measurement value of the to-be-measured quantity at the current moment determined based on a global positioning system, the to-be-measured quantity being an angle.

S402 includes determining a difference between the first attitude angle and the second attitude angle.

S403 includes acquiring a temperature drift calibration value of the gyroscope of the inertial measurement unit in a stationary state.

Alternatively, S403 includes steps 1) to 4).

Step 1) includes acquiring an angular velocity value output by the gyroscope of the inertial measurement unit in the stationary state within a first preset period.

Here, the first preset period may be arbitrarily set according to requirements, and the preferred first preset period is 1 minute.

Step 2) includes determining an initial temperature drift value of the gyroscope of the inertial measurement unit in the stationary state based on the angular velocity value within the first preset period.

Specifically, the angular velocity values within the first preset period are divided into segments, and an average value corresponding to each segment is calculated, and the median of the average values is used as the initial temperature drift value of the gyroscope of the inertial measurement unit in the stationary state.

For example, assuming that the first preset period is 1 minute, for angular velocity values output by the gyroscope of the inertial measurement unit within 1 minute, an average value of angular velocity values for every 100 milliseconds is acquired, that is, 600 average values are acquired, and the median of these 600 average values is used as the initial temperature drift value of the gyroscope of the inertial measurement unit in the stationary state.

Step 3) includes determining an initial attitude angle based on the angular velocity value within the first preset period and the initial temperature drift value.

Specifically, the initial temperature drift value is subtracted from the angular velocity value at each moment within the first preset period respectively, and integration calculation is performed on subtraction results to obtain the initial attitude angle within the first preset period. The specific period of each moment may be set arbitrarily according to requirements, and alternatively includes 1 millisecond or 10 milliseconds.

Step 4) includes determining the temperature drift calibration value of the gyroscope of the inertial measurement unit in the stationary state based on the initial attitude angle.

Alternatively, if the initial attitude angle is 0, the initial temperature drift value is determined as the temperature drift calibration value of the gyroscope of the inertial measurement unit in the stationary state; and if the initial attitude angle is not 0, the initial temperature drift value is corrected to obtain the temperature drift calibration value of the gyroscope of the inertial measurement unit in the stationary state.

Here, if the initial attitude angle is 0, it indicates that the determined initial temperature drift value is accurate, accordingly, the initial temperature drift value is determined as the temperature drift calibration value of the gyroscope of inertial measurement unit in the stationary state. If the initial speed value is not 0, it indicates that the determined initial temperature drift value is deviated, and the initial temperature drift value is corrected. The correction process includes: subtracting a ratio of the initial attitude angle to the first preset period from the initial temperature drift value to acquire a calculation result as the corrected initial temperature drift value. For example, the initial temperature drift value is 1 rad/s, the initial attitude angle is 0.5rad, the first preset period is 1 min, and a calculation result of

$$1 rad \text{/} s - \frac{0.5 rad}{1 min}$$

is used as the corrected initial temperature drift value. Finally, the corrected initial temperature drift value is used as the temperature drift calibration value of the gyroscope of the inertial measurement unit in the stationary state.

S404 includes determining the temperature drift calibration value of the gyroscope of the inertial measurement unit at the current moment, based on the difference between the first attitude angle and the second attitude angle, the temperature drift calibration value of the gyroscope of the inertial measurement unit in the stationary state, and the angular velocity value output by the gyroscope at the current moment.

Alternatively, the temperature drift calibration value of the gyroscope of the inertial measurement unit at the current moment is determined according to the formula as follows:

Delta_yaw=((g−bias2−bias3)*delta_time2)*scale2

Here, Delta_yaw is the difference between the first attitude angle and the second attitude angle, g is the angular velocity value output by the gyroscope at the current moment, bias2 is the temperature drift calibration value of the gyroscope of the inertial measurement unit in the stationary state, delta_time2 is the integral calculation time corresponding to the gyroscope of the inertial measurement unit, which is about 20 s, and scale2 is the preset scale value, preferably taking a value between 1-2.

According to the technical solution of the present embodiment, by acquiring the first attitude angle and the second attitude angle, determining the difference between the first attitude angle and the second attitude angle, acquiring the temperature drift calibration value of the gyroscope of the inertial measurement unit in the stationary state, and finally determining the temperature drift calibration value of the gyroscope of the inertial measurement unit at the current moment, based on the difference between the first attitude angle and the second attitude angle, the temperature drift calibration value of the gyroscope of the inertial measurement unit in the stationary state, and the angular velocity value output by the gyroscope at the current moment, a technical effect of determining the current temperature drift calibration value of the gyroscope of the inertial measurement unit in real time is achieved, which lays a data foundation for subsequent compensation of the gyroscope temperature drift in a navigation dead reckoning algorithm, such that the accuracy of a navigation result is improved.

On the basis of foregoing embodiments, after the “determining the temperature drift calibration value of the gyroscope of the inertial measurement unit in the stationary state based on the initial attitude angle”, the method further includes steps A and B.

Step A includes: acquiring an angular velocity value output by the gyroscope of the inertial measurement unit within a second preset period, when the inertial measurement unit is in the stationary state again.

The second preset period may be configured according to requirements, and is preferably 30 s.

Specifically, when the traveling speed of the traveling device is 0 again, the angular velocity value output by the gyroscope of the inertial measurement unit within a second preset period is acquired.

Step B includes updating the temperature drift calibration value of the gyroscope of the inertial measurement unit in the stationary state, based on the angular velocity value within the second preset period.

Specifically, for the angular velocity values within the second preset period, angular velocity values within a preset error range of the previous temperature drift calibration value of the gyroscope of the inertial measurement unit in the stationary state are used as target angular velocity values, and an average value of the target angular velocity values is used as the updated temperature drift calibration value of the gyroscope of the inertial measurement unit in the stationary state. The preset error range is preferably 30%-50%. The influence of noise on the temperature drift calibration value may be avoided by setting the preset error range.

By updating the temperature drift calibration value of the gyroscope in the stationary state, based on the angular velocity values output by the gyroscope within the second preset period, when the inertial measurement unit is in the stationary state again, a technical effect of updating the temperature drift calibration value of the gyroscope in the stationary state is achieved, so that the accuracy of the temperature drift calibration value of the gyroscope in the stationary state can be guaranteed even when the traveling device switches from moving and stopping for multiple times, thus ensuring the accuracy of the temperature drift calibration value of the gyroscope at the current moment.

On the basis of foregoing embodiments, the angular velocity value output by the gyroscope of the inertial measurement unit is an angular velocity value output by an earth facing axis of the gyroscope.

Correspondingly, the temperature drift calibration value of the gyroscope of the inertial measurement unit in the stationary state is a temperature drift calibration value of the earth facing axis of the gyroscope of the inertial measurement unit in the stationary state.

Specifically, the rotation axis in the gyroscope is used as the earth facing axis.

On the basis of the foregoing embodiment, the method further includes:

performing fitting based on the attitude angle determined by the global positioning system, every set period, or every set distance that vehicle travels.

Specifically, the attitude angle determined by the global positioning system fluctuates greatly due to various factors. In this case, the attitude angle determined by the global positioning system can not be directly used. Therefore, Bessel fitting is performed on the attitude angle determined by the global positioning system every set time, such as 1min, or every set distance that vehicle travels, such as 150 meters. In order to ensure the continuity of the fitting, the fitting is performing using 125 meter position of the last 150 meters as the starting point, using 50 meter position of the current 150 meters as the midpoint, and using 125 meter position of the current segment as the end point

### Embodiment 5

FIG. 5 is a schematic structural diagram of an apparatus 50 for calibrating a temperature drift provided in Embodiment 5 of the present disclosure, which may perform a method for calibrating a temperature drift provided in any embodiment of the present disclosure, and has corresponding functional modules and beneficial effects for performing the method. As shown in FIG. 5, the apparatus may include:

a measurement value acquisition module 51, configured to acquire a first measurement value and a second measurement value; the first measurement value being a measurement value of a to-be-measured quantity at a current moment determined based on an inertial measurement unit; and the second measurement value being a measurement value of the to-be-measured quantity at the current moment determined based on a global positioning system; and

a temperature drift calibration value determination module 52, configured to determine a temperature drift calibration value of the inertial measurement unit at the current moment based on the first measurement value and the second measurement value.

On the basis of foregoing embodiments, the temperature drift calibration value determination module 52 is specifically configured to:

determine a difference between the first measurement value and the second measurement value;

acquire a temperature drift calibration value of the inertial measurement unit in a stationary state; and

determine the temperature drift calibration value of the inertial measurement unit at the current moment, based on the difference and the temperature drift calibration value of the inertial measurement unit in the stationary state.

On the basis of foregoing embodiments, the to-be-measured quantity is speed, the first measurement value is a first speed value, the second measurement value is a second speed value, and the temperature drift calibration value of the inertial measurement unit in the stationary state is a temperature drift calibration value of an accelerometer of the inertial measurement unit in the stationary state;

correspondingly, the temperature drift calibration value determination module 52 is further specifically configured to:

determine a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment.

On the basis of foregoing embodiments, the temperature drift calibration value determination module 52 is further specifically configured to:

determine the temperature drift calibration value bias1 of the accelerometer of the inertial measurement unit at the current moment according to the formula as follows:

Delta_v=((a−bias0−bias1)*delta_time1)*scale1;

here, Delta_v is the difference between the first speed value and the second speed value, a is the acceleration value output by the accelerometer at the current moment, bias0 is the temperature drift calibration value of the accelerometer of the inertial measurement unit in the stationary state, delta_time1 is integral calculation time corresponding to the accelerometer of the inertial measurement unit, and scale1 is a preset scale value.

On the basis of foregoing embodiments, the temperature drift calibration value determination module 52 is further specifically configured to:

acquire an acceleration value output by the accelerometer of the inertial measurement unit in the stationary state within a first preset period;

determine an initial temperature drift value of the accelerometer of the inertial measurement unit in the stationary state based on the acceleration value within the first preset period;

determine an initial speed value based on the acceleration value within the first preset period and the initial temperature drift value; and

determine the temperature drift calibration value of the accelerometer of the inertial measurement unit in the stationary state based on the initial speed value.

On the basis of foregoing embodiments, the temperature drift calibration value determination module 52 is further specifically configured to:

determine the initial temperature drift value as the temperature drift calibration value of the accelerometer of the inertial measurement unit in the stationary state, if the initial speed value is 0; and

correct the initial temperature drift value to obtain the temperature drift calibration value of the accelerometer of the inertial measurement unit in the stationary state, if the initial speed value is not 0.

On the basis of foregoing embodiments, the apparatus further includes a first temperature drift calibration value update module, which is specifically configured to:

acquire an acceleration value output by the accelerometer of the inertial measurement unit within a second preset period, when the inertial measurement unit is in the stationary state again; and

update the temperature drift calibration value of the accelerometer of the inertial measurement unit in the stationary state, based on the acceleration value within the second preset period.

On the basis of foregoing embodiments, the to-be-measured quantity is an angle, the first measurement value is a first attitude angle, the second measurement value is a second attitude angle, and the temperature drift calibration value of the inertial measurement unit in the stationary state is a temperature drift calibration value of a gyroscope of the inertial measurement unit in the stationary state;

correspondingly, the temperature drift calibration value determination module 52 is further specifically configured to:

determine a temperature drift calibration value of the gyroscope of the inertial measurement unit at the current moment, based on a difference between the first attitude angle and the second attitude angle, the temperature drift calibration value of the gyroscope of the inertial measurement unit in the stationary state, and an angular velocity value output by the gyroscope at the current moment.

On the basis of foregoing embodiments, the temperature drift calibration value determination module 52 is further specifically configured to:

determine the temperature drift calibration value bias3 of the gyroscope of the inertial measurement unit at the current moment according to the formula as follows:

Delta_yaw=((g−bias2−bias3)*delta_time2)*scale2

here, Delta_yaw is the difference between the first attitude angle and the second attitude angle, g is the angular velocity value output by the gyroscope at the current moment, bias2 is the temperature drift calibration value of the gyroscope of the inertial measurement unit in the stationary state, delta_time2 is integral calculation time corresponding to the gyroscope of the inertial measurement unit, and scale2 is a preset scale value.

On the basis of foregoing embodiments, the temperature drift calibration value determination module 52 is further specifically configured to:

acquire an angular velocity value output by the gyroscope of the inertial measurement unit within a first preset period in the stationary state;

determine an initial temperature drift value of the gyroscope of the inertial measurement unit in the stationary state based on the angular velocity value within the first preset period;

determine an initial attitude angle based on the angular velocity value within the first preset period and the initial temperature drift value; and

determine the temperature drift calibration value of the gyroscope of the inertial measurement unit in the stationary state based on the initial attitude angle.

On the basis of foregoing embodiments, the temperature drift calibration value determination module 52 is further specifically configured to:

determine the initial temperature drift value as the temperature drift calibration value of the gyroscope of the inertial measurement unit in the stationary state, if the initial attitude angle is 0; and

correct the initial temperature drift value to obtain the temperature drift calibration value of the gyroscope of the inertial measurement unit in the stationary state, if the initial attitude angle is not 0.

On the basis of foregoing embodiments, the apparatus further includes a second temperature drift calibration value update module, which is specifically configured to:

acquire an angular velocity value output by the gyroscope of the inertial measurement unit within a second preset period, when the inertial measurement unit is in the stationary state again; and

update the temperature drift calibration value of the gyroscope of the inertial measurement unit in the stationary state, based on the angular velocity value within the second preset period.

On the basis of foregoing embodiments, the apparatus further includes a navigation result acquisition module, which is specifically configured to:

correct output information of the inertial measurement unit, based on the temperature drift calibration value of the inertial measurement unit, and obtain a navigation dead reckoning result, based on the corrected output information and a navigation dead reckoning algorithm.

The apparatus 50 for calibrating a temperature drift provided in the embodiment of the present disclosure, may implement the method for calibrating a temperature drift provided in any embodiment of the present disclosure, and has the corresponding functional modules and beneficial effects for performing the method. For technical details not described in detail in the present embodiment, reference may be made to a method for calibrating a temperature drift provided by any embodiment of the present disclosure.

According to an embodiment of the present disclosure, the present disclosure further provides an electronic device and a readable storage medium.

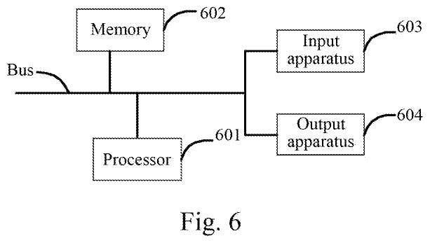

FIG. 6 is a block diagram of an electronic device of the method for calibrating a temperature drift according to an embodiment of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the electronic device includes: one or more processors 601, a memory 602, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories and a plurality of memories if desired. Similarly, a plurality of electronic devices may be connected, and each device provides some necessary operations (for example, a server array, a set of blade servers, or a multi-processor system). In FIG. 6, processor 601 is used as an example.

The memory 602 is a non-transitory computer readable storage medium provided by the present disclosure. The memory stores instructions executable by at least one processor, so that the at least one processor performs the method for calibrating a temperature drift provided by the present disclosure. The non-transitory computer readable storage medium of the present disclosure stores computer instructions for causing a computer to perform the method for calibrating a temperature drift provided by the present disclosure.

The memory 602, as a non-transitory computer readable storage medium, may be used to store non-transitory software programs, non-transitory computer executable programs and modules, such as program instructions/modules corresponding to the method for calibrating a temperature drift in the embodiments of the present disclosure (for example, the measurement value acquisition module 51 and the temperature drift calibration value determination module 52 as shown in FIG. 5). The processor 601 executes the non-transitory software programs, instructions, and modules stored in the memory 602 to execute various functional applications and data processing of the server, that is, to implement the method for calibrating a temperature drift in the foregoing method embodiments.

The memory 602 may include a storage program area and a storage data area, where the storage program area may store an operating system and application program need by at least one function; and the storage data area may store data created by the use of the electronic device for calibrating a temperature drift. In addition, the memory 602 may include a high-speed random access memory, and may also include a non-transitory memory, such as at least one magnetic disk storage device, a flash memory device, or other non-transitory solid-state storage devices. In some embodiments, the memory 602 may optionally include memories remotely disposed with respect to the processor 601, and these remote memories may be connected to the electronic device for calibrating a temperature drift through a network. Examples of the above network include but are not limited to the Internet, blockchain network, intranet, local area network, mobile communication network, and combinations thereof.

The electronic device of the method for calibrating a temperature drift may further include: an input apparatus 603 and an output apparatus 604. The processor 601, the memory 602, the input apparatus 603, and the output apparatus 604 may be connected through a bus or in other methods. In FIG. 6, connection through the bus is used as an example.

The input apparatus 603 may receive input digital or character information, and generate key signal inputs related to user settings and function control of the electronic device for calibrating a temperature drift, such as touch screen, keypad, mouse, trackpad, touchpad, pointing stick, one or more mouse buttons, trackball, joystick and other input apparatuses. The output apparatus 604 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input device, and at least one output device, and transmit the data and instructions to the storage system, the at least one input device and the at least one output device.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display device for displaying information to the user (for example, CRT (cathode ray tube) or LCD (liquid crystal display) monitor); and a keyboard and a pointing device (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other.

According to the technical solution of the embodiments of the present disclosure, by using the measurement value of the to-be-measured quantity at the current moment determined based on the inertial measurement unit as the first measurement value, and using the measurement value of the to-be-measured quantity at the current moment determined b based on the global positioning system as the second measurement value, and finally determining the temperature drift calibration value of the inertial measurement unit at the current moment based on the first measurement value and the second measurement value, a technical effect of determining the current temperature drift calibration value of the inertial measurement unit in real time is achieved, which lays a data foundation for subsequent compensation of the temperature drift in a navigation dead reckoning algorithm, so as to improve the accuracy of a navigation result.

What is claimed is:

1. A method for calibrating a temperature drift, the method comprising:
acquiring a first measurement value and a second measurement value, the first measurement value being a measurement value of a to-be-measured quantity at a current moment determined based on an inertial measurement unit, and the second measurement value being a measurement value of the to-be-measured quantity at the current moment determined based on a global positioning system; and
determining a temperature drift calibration value of the inertial measurement unit at the current moment based on the first measurement value and the second measurement value.

2. The method according to claim 1, wherein the determining a temperature drift calibration value of the inertial measurement unit at the current moment based on the first measurement value and the second measurement value, comprises:
determining a difference between the first measurement value and the second measurement value;
acquiring a temperature drift calibration value of the inertial measurement unit in a stationary state; and
determining the temperature drift calibration value of the inertial measurement unit at the current moment, based on the difference and the temperature drift calibration value of the inertial measurement unit in the stationary state.

3. The method according to claim 2, wherein the to-be-measured quantity is speed, the first measurement value is a first speed value, the second measurement value is a second speed value, and the temperature drift calibration value of the inertial measurement unit in the stationary state is a temperature drift calibration value of an accelerometer of the inertial measurement unit in the stationary state;
correspondingly, the determining the temperature drift calibration value of the inertial measurement unit at the current moment, based on the difference and the temperature drift calibration value of the inertial measurement unit in the stationary state, comprises:
determining a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment.

4. The method according to claim 3, wherein the determining a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment, comprises:
determining the temperature drift calibration value unit at the current moment according to a formula as follows:
Delta_v=((a−bias0−bias1)*delta_time1)*scale1.
wherein, Delta_v is the difference between the first speed value and the second speed value, a is the acceleration value output by the accelerometer at the current moment, bias0 the temperature drift calibration value of the accelerometer of the inertial measurement unit in the stationary state, delta_time1 is integral calculation time corresponding to the accelerometer of the inertial measurement unit, and scale1 is a preset scale value.

5. The method according to claim 3, wherein, the determining the temperature drift calibration value of the accelerometer of the inertial measurement unit in the stationary state, comprises:
acquiring an acceleration value output by the accelerometer of the inertial measurement unit in the stationary state within a first preset period;
determining an initial temperature drift value of the accelerometer of the inertial measurement unit in the stationary state based on the acceleration value within the first preset period;
determining an initial speed value based on the acceleration value within the first preset period and the initial temperature drift value; and
determining the temperature drift calibration value of the accelerometer of the inertial measurement unit in the stationary state based on the initial speed value.

6. The method according to claim 5, wherein the determining the temperature drift calibration value of the accelerometer of the inertial measurement unit in the stationary state based on the initial speed value, comprises:
determining the initial temperature drift value as the temperature drift calibration value of the accelerometer of the inertial measurement unit in the stationary state, in response to determining that the initial speed value is 0; and
correcting the initial temperature drift value to obtain the temperature drift calibration value of the accelerometer of the inertial measurement unit in the stationary state, in response to determining that the initial speed value is not 0.

7. The method according to claim 5, wherein, after the determining the temperature drift calibration value of the accelerometer of the inertial measurement unit in the stationary state based on the initial speed value, the method further comprises:
acquiring an acceleration value output by the accelerometer of the inertial measurement unit within a second preset period, when the inertial measurement unit is in the stationary state again; and
updating the temperature drift calibration value of the accelerometer of the inertial measurement unit in the stationary state, based on the acceleration value within the second preset period.

8. The method according to claim 2, wherein the to-be-measured quantity is an angle, the first measurement value is a first attitude angle, the second measurement value is a second attitude angle, and the temperature drift calibration value of the inertial measurement unit in the stationary state is a temperature drift calibration value of a gyroscope of the inertial measurement unit in the stationary state;
correspondingly, the determining the temperature drift calibration value of the inertial measurement unit at the current moment, based on the difference and the temperature drift calibration value of the inertial measurement unit in the stationary state, comprises:
determining a temperature drift calibration value of the gyroscope of the inertial measurement unit at the current moment, based on a difference between the first attitude angle and the second attitude angle, the temperature drift calibration value of the gyroscope of the inertial measurement unit in the stationary state, and an angular velocity value output by the gyroscope at the current moment.

9. The method according to claim 8, wherein the determining a temperature drift calibration value of the gyroscope of the inertial measurement unit at the current moment, based on a difference between the first attitude angle and the second attitude angle, the temperature drift calibration value of the gyroscope of the inertial measurement unit in the stationary state, and an angular velocity value output by the gyroscope at the current moment, comprises:
determining the temperature drift calibration value at the current moment according to a formula as follows:
Delta_yaw=((g−bias2−bias3)*delta_time2)*scale2
wherein, Delta_yaw is the difference between the first attitude angle and the second attitude angle, g bias3 of the gyroscope of the inertial measurement unit is the angular velocity value output by the gyroscope at the current moment, bias2 is the temperature drift calibration value of the gyroscope of the inertial measurement unit in the stationary state, delta_time2 is integral calculation time corresponding to the gyroscope of the inertial measurement unit, and scale2 is a preset scale value.

10. The method according to claim 8, wherein the determining the temperature drift calibration value of the gyroscope of the inertial measurement unit in the stationary state, comprises:
acquiring an angular velocity value output by the gyroscope of the inertial measurement unit in the stationary state within a first preset period;
determining an initial temperature drift value of the gyroscope of the inertial measurement unit in the stationary state based on the angular velocity value within the first preset period;
determining an initial attitude angle based on the angular velocity value within the first preset period and the initial temperature drift value; and
determining the temperature drift calibration value of the gyroscope of the inertial measurement unit in the stationary state based on the initial attitude angle.

11. The method according to claim 10, wherein the determining the temperature drift calibration value of the gyroscope of the inertial measurement unit in the stationary state based on the initial attitude angle, comprises:
determining the initial temperature drift value as the temperature drift calibration value of the gyroscope of the inertial measurement unit in the stationary state, in response to determining that the initial attitude angle is 0; and
correcting the initial temperature drift value to obtain the temperature drift calibration value of the gyroscope of the inertial measurement unit in the stationary state, in response to determining that the initial attitude angle is not 0.

12. The method according to claim 10, wherein, after the determining the temperature drift calibration value of the gyroscope of the inertial measurement unit in the stationary state based on the initial attitude angle, the method further comprises:
acquiring an angular velocity value output by the gyroscope of the inertial measurement unit within a second preset period, when the inertial measurement unit is in the stationary state again; and
updating the temperature drift calibration value of the gyroscope of the inertial measurement unit in the stationary state, based on the angular velocity value within the second preset period.

13. The method according to claim 1, wherein the method further comprises:
correcting output information of the inertial measurement unit, based on the temperature drift calibration value of the inertial measurement unit, and obtaining a navigation dead reckoning result, based on the corrected output information and a navigation dead reckoning algorithm.

14. An electronic device, comprising:
at least one processor; and
a memory, communicatively connected to the at least one processor; wherein,
the memory stores instructions executable by the at least one processor, and the instructions, when executed by the at least one processor, cause the at least one processor to perform operations, the operations comprising:
acquiring a first measurement value and a second measurement value, the first measurement value being a measurement value of a to-be-measured quantity at a current moment determined based on an inertial measurement unit, and the second measurement value being a measurement value of the to-be-measured quantity at the current moment determined based on a global positioning system; and
determining a temperature drift calibration value of the inertial measurement unit at the current moment based on the first measurement value and the second measurement value.

15. The electronic device according to claim 14, wherein the determining a temperature drift calibration value of the inertial measurement unit at the current moment based on the first measurement value and the second measurement value, comprises:
determining a difference between the first measurement value and the second measurement value;
acquiring a temperature drift calibration value of the inertial measurement unit in a stationary state; and
determining the temperature drift calibration value of the inertial measurement unit at the current moment, based on the difference and the temperature drift calibration value of the inertial measurement unit in the stationary state.

16. The electronic device according to claim 15, wherein the to-be-measured quantity is speed, the first measurement value is a first speed value, the second measurement value is a second speed value, and the temperature drift calibration value of the inertial measurement unit in the stationary state is a temperature drift calibration value of an accelerometer of the inertial measurement unit in the stationary state;
correspondingly, the determining the temperature drift calibration value of the inertial measurement unit at the current moment, based on the difference and the temperature drift calibration value of the inertial measurement unit in the stationary state, comprises:
determining a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment.

17. The electronic device according to claim 16, wherein the determining a temperature drift calibration value of the accelerometer of the inertial measurement unit at the current moment, based on a difference between the first speed value and the second speed value, the temperature drift calibration value of the accelerometer of the inertial measurement unit in the stationary state, and an acceleration value output by the accelerometer at the current moment, comprises:
determining the temperature drift calibration value bias1 of the accelerometer of the inertial measurement unit at the current moment according to a formula as follows:
Delta_v=((a−bias0−bias1)*delta_time1)*scale1;
wherein, Delta_v is the difference between the first speed value and the second speed value, a is the acceleration value output by the accelerometer at the current moment, bias0 is the temperature drift calibration value of the accelerometer of the inertial measurement unit in the stationary state, delta_time1 is integral calculation time corresponding to the accelerometer of the inertial measurement unit, and scale1 is a preset scale value.

18. The electronic device according to claim 16, wherein, the determining the temperature drift calibration value of the accelerometer of the inertial measurement unit in the stationary state, comprises:
acquiring an acceleration value output by the accelerometer of the inertial measurement unit in the stationary state within a first preset period;
determining an initial temperature drift value of the accelerometer of the inertial measurement unit in the stationary state based on the acceleration value within the first preset period;
determining an initial speed value based on the acceleration value within the first preset period and the initial temperature drift value; and
determining the temperature drift calibration value of the accelerometer of the inertial measurement unit in the stationary state based on the initial speed value.

19. The electronic device according to claim 18, wherein the determining the temperature drift calibration value of the accelerometer of the inertial measurement unit in the stationary state based on the initial speed value, comprises:
determining the initial temperature drift value as the temperature drift calibration value of the accelerometer of the inertial measurement unit in the stationary state, in response to determining that the initial speed value is 0; and
correcting the initial temperature drift value to obtain the temperature drift calibration value of the accelerometer of the inertial measurement unit in the stationary state, in response to determining that the initial speed value is not 0.

20. A non-transitory computer readable storage medium, storing computer instructions, the computer instructions, being executable to cause a computer to perform operations, the operations comprising:
acquiring a first measurement value and a second measurement value, the first measurement value being a measurement value of a to-be-measured quantity at a current moment determined based on an inertial measurement unit, and the second measurement value being a measurement value of the to-be-measured quantity at the current moment determined based on a global positioning system; and
determining a temperature drift calibration value of the inertial measurement unit at the current moment based on the first measurement value and the second measurement value.
